(19) United States
(12) Patent Application Publication
(10) Pub. No.: US 2025/0015742 A1
(43) Pub. Date: Jan. 9, 2025

(54) MULTI-SWITCH MODULE PACKAGING FOR MULTILEVEL INVERTER

(71) Applicant: GM GLOBAL TECHNOLOGY OPERATIONS LLC, DETROIT, MI (US)

(72) Inventors: Rashmi Prasad, Troy, MI (US); Chandra S. Namuduri, Troy, MI (US); Muhammad Hussain Alvi, Troy, MI (US); Junghoon Kim, ANN ARBOR, MI (US); Khorshed Mohammed Alam, Canton, MI (US); Thomas W. Nehl, Shelby Twp., MI (US); Yilun Luo, Ann Arbor, MI (US)

(21) Appl. No.: 18/347,883

(22) Filed: Jul. 6, 2023

(51) Int. Cl. H02P 27/06; B60L 50/60; H02M 7/537

(52) U.S. Cl. CPC H02P 27/06; B60L 50/60; H02M 7/537; B60L 2210/42

(57) ABSTRACT

Multi-switch module packaging for a multilevel inverter is provided. A multilevel inverter is connected to the battery. The multilevel inverter includes three levels, each of the three levels having a first module and a second module. The first module is formed on a first insulating substrate material, and the second module is formed on a second insulating substrate material separate from the first insulating substrate material. The first module includes a first switch coupled to the battery via a positive power rail, a second switch coupled to the battery via a negative power rail, and a third switch coupled to the second module. The second module includes another first switch coupled to the battery, another second switch coupled to the battery, and another third switch coupled to the first module. The first module includes four terminals and the second module includes another four terminals.

### INTRODUCTION

The disclosure relates to power control systems for a vehicle, and more particularly to providing multi-switch module packaging for a multilevel inverter.

In general, vehicles include many different electrical systems. These electrical systems include, but are not limited to, infotainment systems, lighting systems, power steering systems, power braking system, driver assistance systems, various sensors, heating systems, and air conditioning systems, and the like.

Recently, electric and hybrid vehicles have been developed which include high voltage (i.e., >400V) battery packs, and it is desirable to improve battery inverters.

### SUMMARY

In one exemplary embodiment, a vehicle system is provided. The vehicle system includes a battery, and a multilevel inverter connected to the battery. The multilevel inverter includes three levels, each of the three levels including a first module and a second module, the first module being formed on a first insulating substrate material, the second module being formed on a second insulating substrate material separate from the first insulating substrate material. The first module includes a first switch coupled to the battery via a positive power rail, a second switch coupled to the battery via a negative power rail, and a third switch coupled to the second module. The second module includes another first switch coupled to the battery, another second switch coupled to the battery, and another third switch coupled to the first module. The first module includes four terminals and the second module includes another four terminals.

In addition to the one or more features described herein the first module is a separate assembly than the second module.

In addition to the one or more features described herein the multilevel inverter includes a total of six separate modules.

In addition to the one or more features described herein the first module and the second module form one phase that is operatively coupled to a motor, such that a combination of the three levels of the multilevel inverter provides three phase voltage to the motor.

In addition to the one or more features described herein a drain of the third switch in the first module connects to a drain of the another third switch in the second module.

In addition to the one or more features described herein the first module and the second module are each independently assembled and removable from the multilevel inverter.

In addition to the one or more features described herein one of the four terminals and the another four terminals is connected to the positive power rail while another one of the four terminals and the another four terminals is connected the negative power rail.

In one exemplary embodiment, a method is provided for configuring a vehicle system. The method includes coupling a multilevel inverter to a battery, the multilevel inverter comprising three levels, each of the three levels including a first module and a second module, the first module being formed on a first insulating substrate material, the second module being formed on a second insulating substrate material separate from the first insulating substrate material. The method includes configuring the first module with a first switch coupled to the battery via a positive power rail, a second switch coupled to the battery via a negative power rail, and a third switch coupled to the second module. Also, the method includes configuring the second module with another first switch coupled to the battery, another second switch coupled to the battery, and another third switch coupled to the first module, where the first module comprises four terminals and the second module comprises another four terminals.

In addition to the one or more features described herein the first module is a separate assembly than the second module.

In addition to the one or more features described herein the multilevel inverter comprises a total of six separate modules.

In addition to the one or more features described herein the first module and the second module form one phase that is operatively coupled to a motor, such that a combination of the three levels of the multilevel inverter provides three phase voltage to the motor.

In addition to the one or more features described herein a drain of the third switch in the first module connects to a drain of the another third switch in the second module.

In addition to the one or more features described herein the first module and the second module are each independently assembled and removable from the multilevel inverter.

In one exemplary embodiment, a vehicle system is provided. The vehicle system includes a battery, and a multilevel inverter connected to the battery. The multilevel inverter includes modules and three levels, each of the three levels including one of the modules, each of the modules including insulating substrate material separate from another one of the modules. Each of the modules includes first switches coupled to the battery via a positive power rail, second switches coupled to the battery via a negative power rail, and third switches coupled to each other. Each of the modules includes four terminals.

In addition to the one or more features described herein each of the modules is a separate assembly from the another one of the modules.

In addition to the one or more features described herein the multilevel inverter includes a total of three separate ones of the modules.

In addition to the one or more features described herein each of the modules forms one phase that is operatively coupled to a motor, such that a combination of the three levels of the multilevel inverter provides three phase voltage to the motor.

In addition to the one or more features described herein drains of the third switches are connected together.

In addition to the one or more features described herein each of the modules is independently assembled and removable from the multilevel inverter.

In addition to the one or more features described herein one of the four terminals is connected to the positive power rail while another one of the four terminals is connected the negative power rail.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a schematic illustrating a vehicle system having a power supply system connected to motor in accordance with an exemplary embodiment;

FIG. 3 is a schematic illustrating example modules in a level of an inverter for a vehicle in accordance with an exemplary embodiment;

FIG. 4 is a schematic illustrating an example module in a level of an inverter for a vehicle in accordance with an exemplary embodiment;

FIGS. 5A and 5B illustrate an example switch assembly as of one of the modules depicted in FIG. 3 in accordance with an exemplary embodiment;

FIG. 5C illustrates a portion of the multilevel inverter depicted in FIGS. 5A and 5B in accordance with an exemplary embodiment;

FIG. 6A illustrates an example switch assembly of the module 420 depicted in FIG. 4 in accordance with an exemplary embodiment;

FIG. 6B illustrates a portion of the multilevel inverter depicted in FIG. 6A in accordance with an exemplary embodiment;

FIG. 7 is a schematic illustrating an example multilevel inverter having two modules in accordance with an exemplary embodiment;

FIG. 8 is a schematic illustrating an example multilevel inverter having two modules in accordance with an exemplary embodiment;

FIG. 9 is a schematic illustrating an example multilevel inverter having three modules in accordance with an exemplary embodiment; and

FIG. 10 is a flowchart of a method for providing multi-switch module packaging for a multilevel inverter in accordance with an exemplary embodiment.

### DETAILED DESCRIPTION

The following description is merely exemplary in nature and is not intended to limit the present disclosure, its application or uses.

Multiple switches working together for any multilevel inverter application will require a larger mounting space due to the extra space for the switch housing and protection. Multiple housings may introduce more stray inductances and parasitics, thereby causing higher device and motor stresses especially at higher voltages.

According to one or more exemplary embodiments, a multi-switch module packaging for a multilevel inverter. One or more embodiments provide an electronic solid state multiple switch module capable (but not a necessity) of carrying, for example, at least 200 amperes (A) continuously, which is suitable for use in a multilevel inverter topology. The switch assembly can include, for example, three or six, power semiconductor switches packaged together for tight assembly and minimum parasitics to enable high power density and minimum stresses on the devices at higher voltage.

Technical effects and solutions include multiple switches attached on a single insulated substrate within a single package thereby forming a module, which can reduce the cumulative package size by 15% and lower the mass. Each switch can be composed of a plurality of power semiconductor devices configured as a silicon/silicon carbide (Si/SiC) metal-oxide-semiconductor field-effect (MOSFET), gallium nitride (GaN) FET, Si insulated-gate bipolar transistor (IGBT) or hybrid device using a combination of these. One or more embodiments provide a layout that functionally works as a three switch or six switch inverter module with (only) the minimum required four terminals, thereby saving package size and cost. The package may include gate drivers for the multiple switches. One or more embodiments can provide better thermal management with an optimal integrated heat sink. For the heat sink, there can be a single side cooled or double side cooled configuration. The multilevel module switch enables inter-module stray parasitic reduction. In one or more embodiments, switch 5 (SW5) dies may have different ratings than switch 1 (SW1) and switch 2 (SW2) dies within the module.

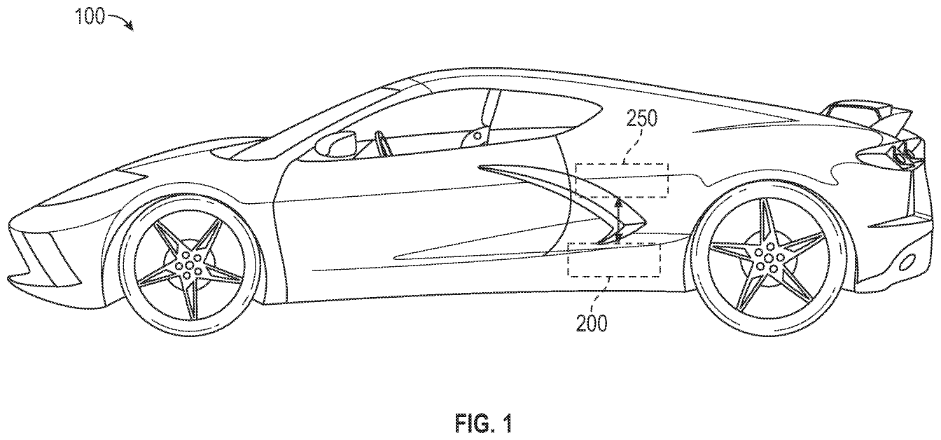

Referring now to FIG. 1, a schematic diagram of a vehicle 100 for use in conjunction with one or more embodiments of the present disclosure is shown. The vehicle 100 includes a power supply system 200. In one embodiment, the vehicle 100 is a hybrid vehicle that utilizes both an internal combustion engine and an electric motor drive system. In another embodiment, the vehicle 100 is one of an electric vehicle propelled only by an electric motor or multiple electric motors 250. In another embodiment, the vehicle 100 can be of a conventional type and propelled by an internal combustion engine.

Electric vehicles (EVs) such as battery electric vehicles (BEVs), hybrid vehicles, and/or fuel cell vehicles include one or more electric machines and a high-voltage battery pack. A power control system (not shown) is used to control charging and/or discharging of the high-voltage battery system. The power control system includes an accessory power module (APM) that is configured to provide low-voltage power to one or more electrical systems of the vehicle.

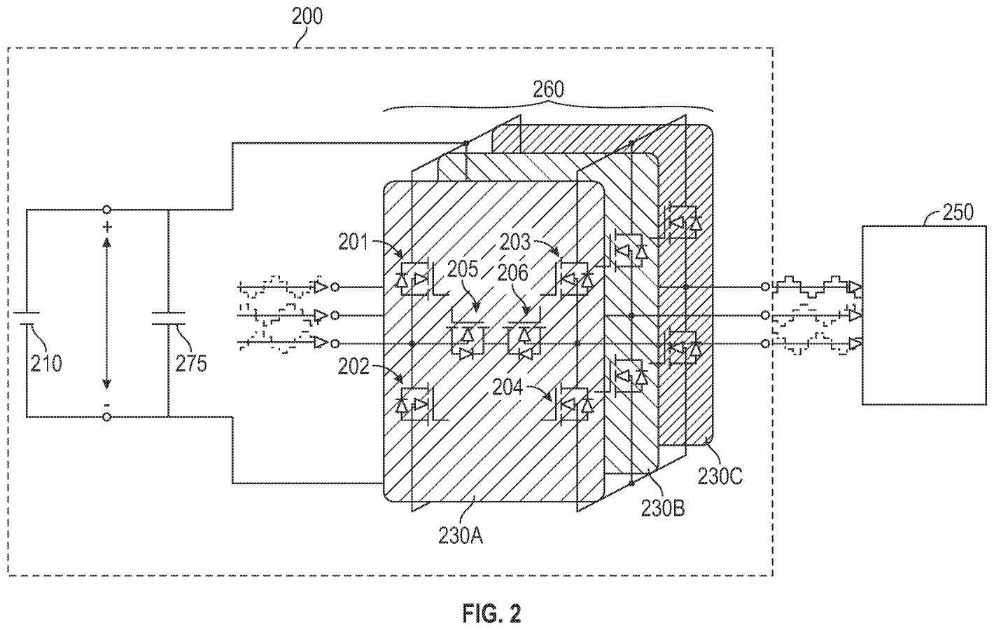

Referring now to FIG. 2, a block diagram illustrating a portion of power supply system 200 for a vehicle in accordance with an exemplary embodiment is shown. The power supply system 200 includes a high voltage battery 210. The high voltage battery 210 may include high voltage battery modules having batteries that are connected in series to form a high voltage battery pack. The high voltage battery pack may be connected to a DC/DC converter (not shown) that is configured to provide a reduced, or low voltage, to a low voltage bus or to a low voltage battery.

In FIG. 2, the power supply system 200 is connected to a motor 250. The power supply system 200 includes a multilevel inverter 260 that include, for example, level 230A, level 230B, and level 230C. Each level includes switches 201, 202, and 205 and switches 203, 204, and 206. The switch 201 can be referred to as switch 1 or SW1, switch 202 can be referred to as SW2, and switch 205 can be referred to as SW5. Similarly, the switch 203 can be referred to as SW3, switch 204 can be referred to as SW4, and switch 206 can be referred to as SW6.

The switches 201, 203, 205, 202, 204, and 206 are each illustrated as a transistor in parallel with a diode and can be referred to as power semiconductor switches. As the input terminals to the switches, the gates of the switches 201, 203, 205, 202, 204, and 206 are configured to be controlled for the desired operation. The multilevel inverter 260 is illustrated with the level 230A, level 230B, and level 230C connected in parallel, and each level is connected to the motor 250. The levels 230A, 230B, and 230B are connected to capacitor 275 that is in parallel with the high voltage battery 210. Each level is one phase, such that three levels correspond to three phase voltage output to the motor 250. Although one level may be discussed at times, the discussions apply by analogy to the other levels in the multilevel inverter.

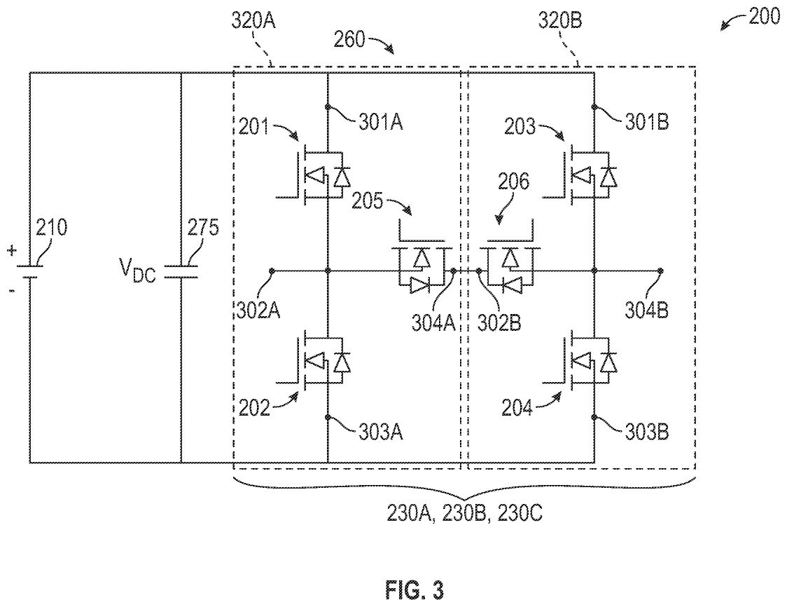

Referring now to FIG. 3, a schematic is shown illustrating a portion of the multilevel inverter 260 having two modules connected to the high voltage battery 210 in accordance with an exemplary embodiment. In FIG. 3, the level shown could be representative of any of the levels 230A, 230B, and 230C, where each level has the same topology. In accordance with one or more embodiments, the example level of the multilevel inverter 260 includes two modules, illustrated as module 320A and module 320B. The module 320A include switches 201, 202, and 205 and has four terminals 301A, 302A, 303A, and 304A. The terminal 301A is connected to the positive power rail, while the terminal 303A is connected to the negative power rail. The terminal 302A is the terminal that provides the output voltage A1, for example, the Vout A1 terminal.

The module 320B includes switches 203, 204, and 206 and has four terminals 301B, 302B, 303B, and 304B. The terminal 301B is connected to the positive power rail, while the terminal 303B is connected to the negative power rail. The terminal 304B is the terminal that provides the output voltage A2, for example, the Vout A2 terminal. Each module 320A and 320B is a separate package assembled to be operatively connected together, thereby forming one level of the multilevel inverter 260. The four terminals in each module can be pins that extend from the module for connection.

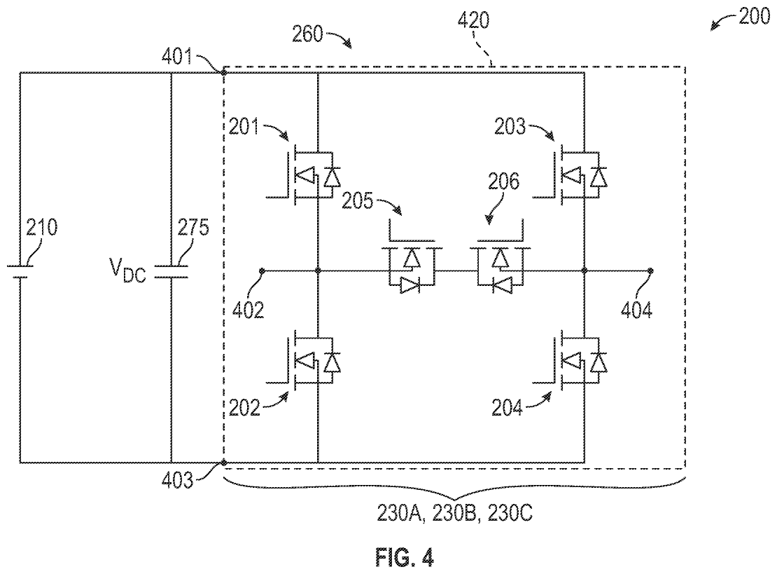

FIG. 4 is a schematic illustrating a portion of the multilevel inverter 260 having a single module connected to the high voltage battery 210 in accordance with an exemplary embodiment. The level shown could be representative of any of the levels 230A, 230B, and 230C. In accordance with one or more embodiments, the example level of the multilevel inverter 260 includes a single module, illustrated as module 420. In other words, a single module is utilized per level. The module 420 includes the switches 201, 202, and 205, the switches 203, 204, and 206, and four terminals 401, 402, 403, and 404. The terminal 401 is connected to the positive power rail, while the terminal 403 is connected to the negative power rail. The terminal 402 is the terminal that provides the output voltage A1, for example, the Vout A1 terminal. The terminal 404 is the terminal that provides the output voltage A2, for example, the Vout A2 terminal. The module 420 is a single package assembled to be operatively connected to two more modules 420, where each module 420 forms one level of the multilevel inverter 260.

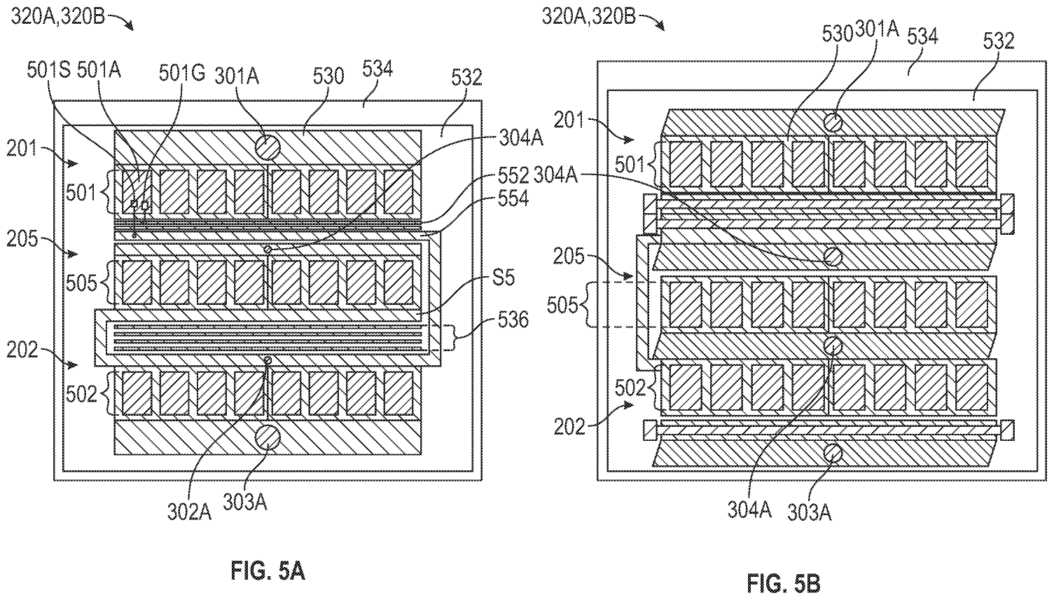

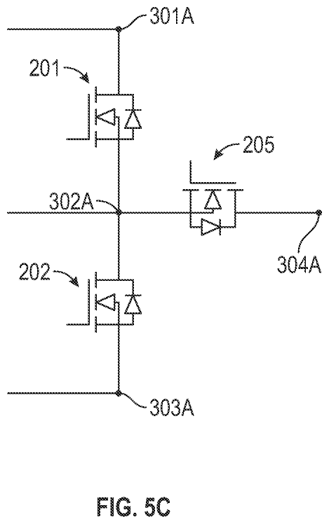

FIGS. 5A and 5B illustrate an example switch assembly as of one of the modules depicted in FIG. 3 in accordance with an exemplary embodiment. FIG. 5A illustrates the front of the module, while FIG. 5B illustrates the back of the module with one or more layers removed for the sake of conciseness. FIG. 5C illustrates a portion of the multilevel inverter 260. FIGS. 5A and 5B illustrate a layout with three switches, which uses two modules per phase (one module shown but it is understood that two modules are connected together per level), resulting in six modules per inverter. In FIG. 5C, source S1 and drain D1 are identified for the switch 201, source S2 and drain D2 are identified for the switch 202, and source S5 and drain D5 are identified for the switch 205. This applies by analogy to the module for switches 203, 204, and 206.

In the module of FIGS. 5A and 5B, the switch 201 includes one or more dies 501 connected in parallel, the switch 202 includes one or more dies 502 connected in parallel, and the switch 205 includes one or more dies 505 connected in parallel. Each of the dies 501, 502, and 505 is an integrated circuit having semiconductor material to form the respective switches. Conductive material 530 connects the dies to form the respective switches, and the conductive material 530 provide conductive lines for the sources, gates, and drains of the switches, along with the positive power rail and the negative power rail. Also, the conductive material 530 is used to interconnect the switches. Examples of the conductive material 530 can include copper, aluminum, gold, etc. To avoid unnecessarily obscuring FIGS. 5A and 5B, every interconnection from the dies to respective source and gate conductive lines, as well as a connection to the respective drain, is not illustrated. For explanation purposes, one die 501 of the switch 201 is highlighted as die 501A to illustrate example connections to the source and gate conductive lines in FIG. 5A. In FIG. 5A, a gate connection 501G for the gate of the die 501A is connected to a gate conductive line 552, and a source connection 501S for the source of the die 501A is connected to a source conductive line 554. The drain connection can be a pin/connection (not shown) on the back side of the die 501A to the drain D1. The drain conductive lines can include plates of conductive material 530. The conductive material 530 can be formed on and within an insulating substrate material 532 in order to make the proper connections for the dies forming the respective switches 201, 202, and 205 in the module 320A, which correspondingly apply to switches 203, 204, and 206 in the module 320B. Other gate conductive lines 536 are illustrated. The insulating substrate material 532 can be formed on a thermal sink 534. The insulating substrate material 532 includes an insulator that block the flow of electrical current. Since each module is assembled in a separate package, each module has components formed on its own insulating substrate material 532 distinct and separate from another module in its own package.

With reference to FIGS. 5A, 5B, and 5C, there are four terminals 301A, 302A, 303A, and 304A utilized for connection outside of the module. In FIG. 5A, the terminals 301A, 302A, 303A, and 304A are shown connected to the conductive material 530, while in FIG. 5B, the terminals 301A, 302A, 303A, and 304A extend through a portion of the insulating substrate material 532. The terminal 301A is connected to and has the same voltage potential as the drain D1 and the positive power rail. The terminal 302A is connected to and has the same voltage potential as the source S1, the drain D2, and the source S5. The terminal 303A is connected to and has the same voltage potential as the source S2 and the negative power rail. The terminal 304A is connected to and has the same voltage potential as the drain D5.

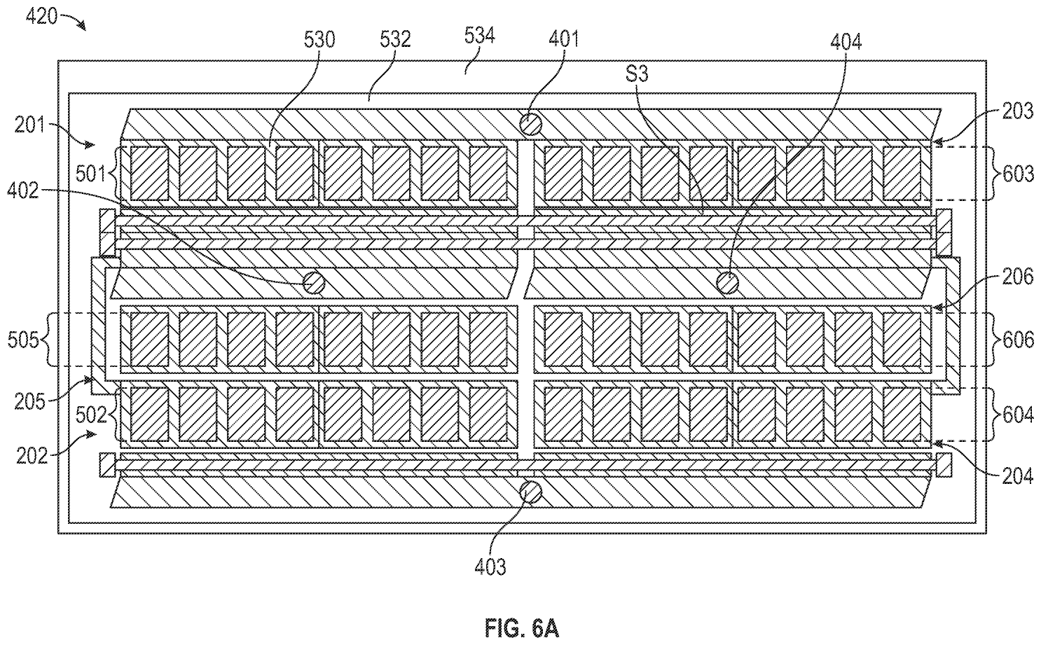

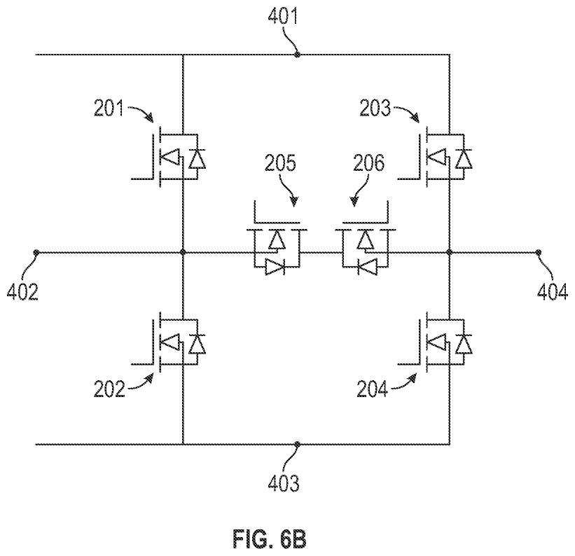

FIG. 6A illustrates an example switch assembly of the module 420 depicted in FIG. 4 in accordance with an exemplary embodiment. FIG. 6B illustrates a portion of the multilevel inverter 260. FIG. 6A illustrates a layout with six switches, which uses one module per phase, resulting in using three modules per inverter. Each level has a single module. Although the one module 420 is depicted in FIG. 6A, three modules are connected in parallel at the positive and negative power rails to form the multilevel inverter 260. In FIG. 6B, source S1 and drain D1 are identified for the switch 201, source S2 and drain D2 are identified for the switch 202, and source S5 and drain D5 are identified for the switch 205. Similarly, source S3 and drain D3 are identified for the switch 203, source S4 and drain D4 are identified for the switch 204, and source S6 and drain D6 are identified for the switch 206.

In the module 420 of FIG. 6A, the switch 201 includes one or more dies 501 connected in parallel, the switch 202 includes one or more dies 502 connected in parallel, and the switch 205 includes one or more dies 505 connected in parallel, analogous to the discussion in FIGS. 5A and 5B. Additionally, in the module 420, the switch 203 includes one or more dies 603 connected in parallel, the switch 206 includes one or more dies 606 connected in parallel, and the switch 204 includes one or more dies 604 connected in parallel. As discussed herein, each of the dies 501, 502, and 505, as well as the dies 603, 604, and 606, is an integrated circuit having semiconductor material to form the respective switches. Conductive material 530 connects the dies to form the respective switches, and the conductive material 530 provide conductive lines for the sources, gates, and drains of the switches, along with the positive power rail and the negative power rail. Also, the conductive material 530 is used to interconnect the switches. Examples of the conductive material 530 can include copper, aluminum, gold, etc. To avoid unnecessarily obscuring FIG. 6A, every interconnection from the dies to respective source, drain, and gate conductive lines is not illustrated. The conductive material 530 can be formed on and within an insulating substrate material 532 in order to make the proper connections for the dies forming the respective switches 201, 202, and 205 and the respective switches 203, 204, and 206 in the module 420.

With reference to FIG. 6A, there are four terminals 301A, 302A, 303A, and 304A exposed and utilized for connection outside of the module. In FIG. 6A, the terminals 401, 402, 403, and 404 extend through a portion of the insulating substrate material 532. The terminal 401 is connected to and has the same voltage potential as the drain D1, drain D3, and the positive power rail. The terminal 402 is connected to and has the same voltage potential as the source S1, the drain D2, and the source S5. The terminal 403 is connected to and has the same voltage potential as the source S2, the source S4, and the negative power rail. The terminal 404 is connected to and has the same voltage potential as the source S3, the source S6, and the drain D5.

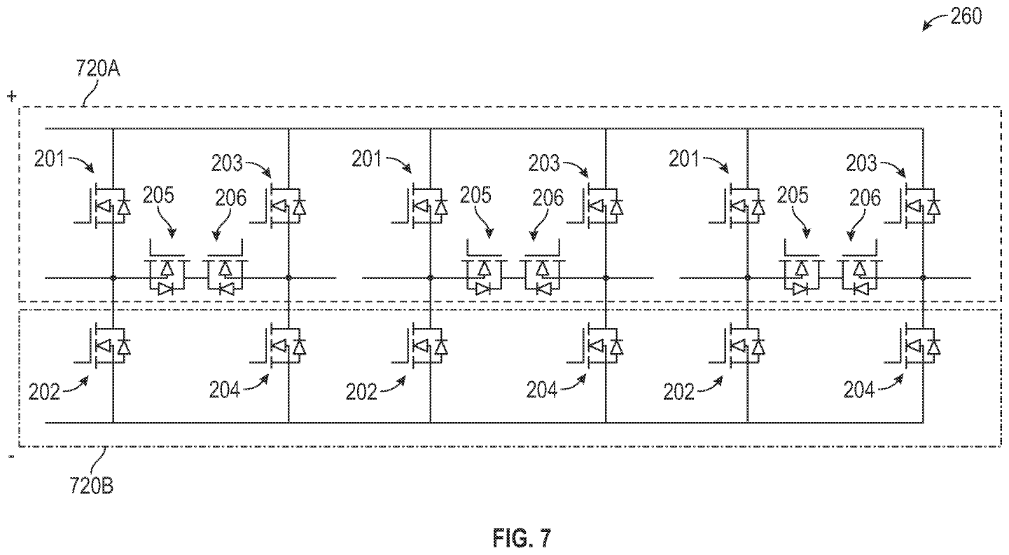

FIG. 7 is a schematic illustrating an example of the multilevel inverter 260 having two modules connected to the high voltage battery 210 in accordance with an exemplary embodiment. In FIG. 7, the inverter layout is illustrated with two asymmetric modules 720A and 720B. The module 720A includes twelve switches and the module 720B include six switches. A technical effect or benefit is that (only) two housings are utilized, thereby having less volume and mass and providing a compact structure so as to reduce the inter-module parasitics. The module 720A includes a repeat of the switches 201, 203, 205, and 206 to result in twelve switches. The module 720B includes a repeat of switches 202 and 204 to result in six switches. The module 720A is connected to the positive power rail, while the module 720B is connected to the negative power rail. Each module 720A and 720B is a separate package assembled to be operatively connected, thereby forming the multilevel inverter 260. In FIG. 7, only one level is needed.

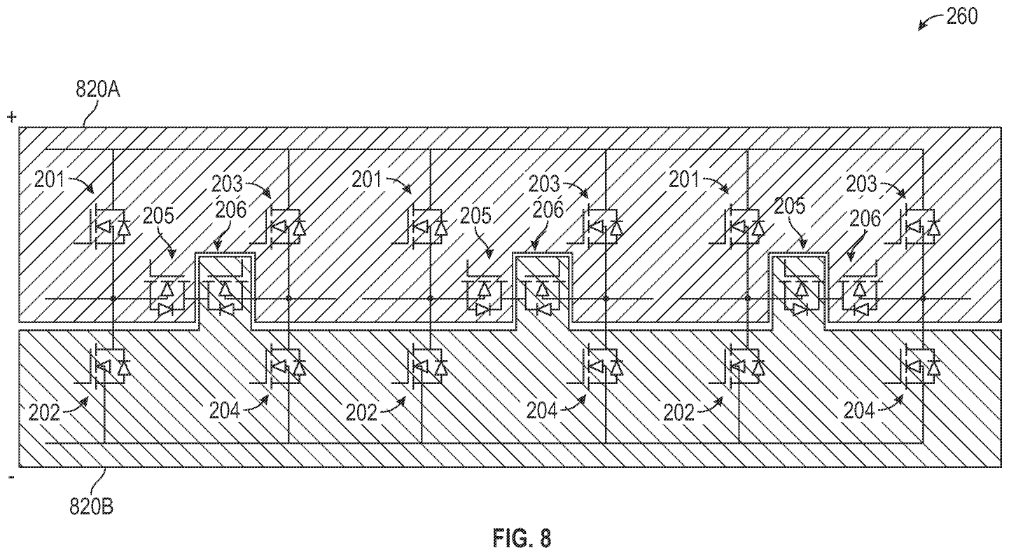

FIG. 8 is a schematic illustrating an example of the multilevel inverter 260 having two modules connected to the high voltage battery 210 (not shown in FIG. 8) in accordance with an exemplary embodiment. An inverter layout is provided with two symmetric modules. FIG. 8 shows two modules 820A and 820B, where each has nine switches. Module 820A is formed with a repeat of switches 201, 203, and 205, reaching a total of nine switches. Module 820B is formed with a repeat of switches 202, 204, and 206, reaching a total of nine switches. In FIG. 8, only one level is needed.

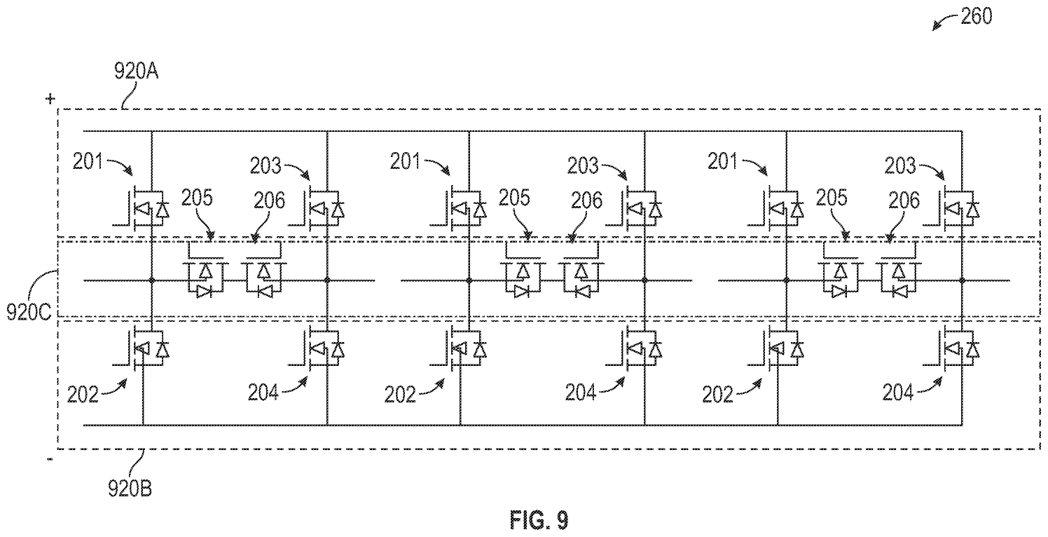

FIG. 9 is a schematic illustrating an example of the multilevel inverter 260 having three modules connected to the high voltage battery 210 (not shown in FIG. 9) in accordance with an exemplary embodiment. An inverter layout is provided with two symmetric modules and one different module. FIG. 9 shows two symmetric modules 920A and 920B, where each has six switches performing complementary functions in which module 920A is connected to the positive power rail and module 920B is connected to the negative power rail. Module 920A is formed with a repeat of switches 201, and 203, reaching a total of six switches. Module 920B is formed with a repeat of switches 202 and 204, reaching a total of six switches. A module 920C is formed with a repeat of switches 205 and 206, resulting in a total of six switches. In FIG. 9, only one level is needed.

Technical effects and solutions include a multi-switch module with four terminals. Per module, the multiple switches attached on a single insulated substrate within a single package, thereby reducing the cumulative package size by greater than (>) 20% and providing a lower mass for a three switch or a six switch module. The single package includes the power devices with optimal integrated heat sink (single side or double side cooling) and with power and control terminals. The heat sink can be monolithic or distributed. The power modules vertical thermal stack can be selected based on single side cooling or double side cooling. The package may also house decoupling capacitors and a gate driver circuit for the switches. Each switch is composed of a plurality of power semiconductor devices configured as a Si/SiC MOSFET, GaN FET (vertical or lateral), Si IGBT, or hybrid device using a combination of these. One or more embodiments provide a layout that functionally works as a three switch or six switch inverter module with (only) the minimum required four terminals, thereby saving package size and cost. The gate-source signal terminals can be placed on a printed circuit board (PCB) integrated within the module or etched traces on the directed bonded copper (DBC) substrate. The multi-module switch enables inter-module stray parasitic reduction as compared to three discrete devices or half bridge with a discrete switch for a three switch module. In one or more embodiments, the SW5/SW6 dies may have different voltage ratings than SW1/SW3 and SW2/SW4 dies within the module. One or more embodiments can have a symmetric optimal arrangement of dies.

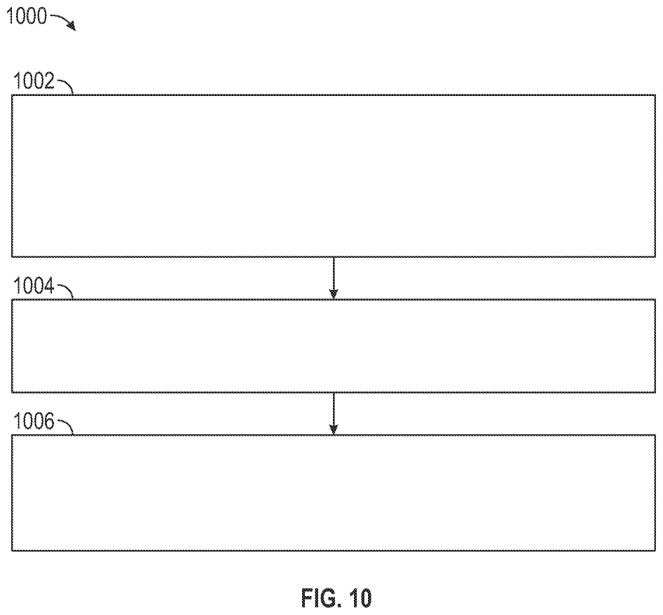

FIG. 10 is a flowchart of a method 1000 for providing multi-switch module packaging for a multilevel inverter in accordance with an exemplary embodiment. Reference can be made to any of the figures discussed herein.

At block 1002, the method 1000 includes coupling a multilevel inverter 260 to a battery 210, the multilevel inverter 260 including three levels 230A, 230B, and 230C, each of the three levels including a first module 320A and a second module 320B, the first module being formed on a first insulating substrate material 532 (in the module 320A), the second module being formed on a second insulating substrate material 532 (in the module 320B) separate from the first insulating substrate material.

At block 1004, the method 1000 includes configuring the first module 320A with a first switch (e.g., switch 201) coupled to the battery 210 via a positive power rail, a second switch (e.g., switch 202) coupled to the battery 210 via a negative power rail, and a third switch (e.g., switch 205) coupled to the second module (e.g., module 320B).

At block 1006, the method 1000 includes configuring the second module 320B with another first switch (e.g., switch 203) coupled to the battery 210, another second switch (e.g., switch 204) coupled to the battery 210, and another third switch (e.g., switch 206) coupled to the first module (e.g., module 320A), where the first module includes four terminals (e.g., terminals 301A, 302A, 303A, and 304A) and the second module includes another four terminals (e.g., terminals 301B, 302B, 303B, and 304B).

In one or more embodiments, the first module is a separate assembly than the second module. The multilevel inverter 260 includes a total of six separate modules, for example, two modules 320A and 320B in each of the three levels 230A, 230B, and 230C. The first module and the second module form one phase that is operatively coupled to a motor 250, such that a combination of the three levels of the multilevel inverter provides three phase voltage to the motor 250. A drain D5 of the third switch in the first module connects to a drain D6 of the another third switch in the second module. The first module 320A and the second module 320B are each independently assembled and removable from the multilevel inverter 260.

In one or more embodiments, a vehicle system includes a battery 210 and a multilevel inverter 260 connected to the battery. The multilevel inverter 260 includes modules 420 and three levels 230A, 230B, and 230C. Each of the three levels has one of the modules 420, each of the modules 420 including insulating substrate material 532 separate from another one of the modules 420. Each of the modules 420 includes first switches (e.g., switches 201 and 203) coupled to the battery 210 via a positive power rail, second switches (e.g., switches 202 and 204) coupled to the battery 210 via a negative power rail, and third switches (e.g., switches 205 and 206) coupled to each other. Each of the modules 420 comprises four terminals (e.g., terminals 401, 402, 403, and 404).

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure be limited to the particular embodiments disclosed, but will include all embodiments falling within the scope thereof.

What is claimed is:

1. A vehicle system comprising:
a battery; and
a multilevel inverter connected to the battery, the multilevel inverter comprising three levels, each of the three levels comprising a first module and a second module, the first module being formed on a first insulating substrate material, the second module being formed on a second insulating substrate material separate from the first insulating substrate material;
wherein the first module comprises a first switch coupled to the battery via a positive power rail, a second switch coupled to the battery via a negative power rail, and a third switch coupled to the second module;
wherein the second module comprises another first switch coupled to the battery, another second switch coupled to the battery, and another third switch coupled to the first module; and
wherein the first module comprises four terminals and the second module comprises another four terminals.

2. The vehicle system of claim 1, wherein the first module is a separate assembly than the second module.

3. The vehicle system of claim 1, wherein the multilevel inverter comprises a total of six separate modules.

4. The vehicle system of claim 1, wherein the first module and the second module form one phase that is operatively coupled to a motor, such that a combination of the three levels of the multilevel inverter provides three phase voltage to the motor.

5. The vehicle system of claim 1, wherein a drain of the third switch in the first module connects to a drain of the another third switch in the second module.

6. The vehicle system of claim 1, wherein the first module and the second module are each independently assembled and removable from the multilevel inverter.

7. The vehicle system of claim 1, wherein one of the four terminals and the another four terminals is connected to the positive power rail while another one of the four terminals and the another four terminals is connected the negative power rail.

8. A vehicle system comprising:
a battery; and
a multilevel inverter connected to the battery, the multilevel inverter comprising modules and three levels, each of the three levels comprising one of the modules, each of the modules comprising insulating substrate material separate from another one of the modules;
wherein each of the modules comprises first switches coupled to the battery via a positive power rail, second switches coupled to the battery via a negative power rail, and third switches coupled to each other; and
wherein each of the modules comprises four terminals.

9. The vehicle system of claim 8, wherein each of the modules is a separate assembly from the another one of the modules.

10. The vehicle system of claim 8, wherein the multilevel inverter comprises a total of three separate ones of the modules.

11. The vehicle system of claim 8, wherein each of the modules forms one phase that is operatively coupled to a motor, such that a combination of the three levels of the multilevel inverter provides three phase voltage to the motor.

12. The vehicle system of claim 8, wherein drains of the third switches are connected together.

13. The vehicle system of claim 8, wherein each of the modules is independently assembled and removable from the multilevel inverter.

14. The vehicle system of claim 8, wherein one of the four terminals is connected to the positive power rail while another one of the four terminals is connected the negative power rail.

15. A method for configuring a vehicle system, the method comprising:
coupling a multilevel inverter to a battery, the multilevel inverter comprising three levels, each of the three levels comprising a first module and a second module, the first module being formed on a first insulating substrate material, the second module being formed on a second insulating substrate material separate from the first insulating substrate material;
configuring the first module with a first switch coupled to the battery via a positive power rail, a second switch coupled to the battery via a negative power rail, and a third switch coupled to the second module; and
configuring the second module with another first switch coupled to the battery, another second switch coupled to the battery, and another third switch coupled to the first module, wherein the first module comprises four terminals and the second module comprises another four terminals.

16. The method of claim 15, wherein the first module is a separate assembly than the second module.

17. The method of claim 15, wherein the multilevel inverter comprises a total of six separate modules.

18. The method of claim 15, wherein the first module and the second module form one phase that is operatively coupled to a motor, such that a combination of the three levels of the multilevel inverter provides three phase voltage to the motor.

19. The method of claim 15, wherein a drain of the third switch in the first module connects to a drain of the another third switch in the second module.

20. The method of claim 15, wherein the first module and the second module are each independently assembled and removable from the multilevel inverter.
